(19) United States
(12) Patent Application Publication
(10) Pub. No.: US 2011/0035983 A1
(43) Pub. Date: Feb. 17, 2011

(54) FIREARM TOOL SYSTEM AND METHOD FOR USING

(76) Inventor: Scott F. Conti, Greenfield, MA (US)

Correspondence Address: BURNS & LEVINSON, LLP, 125 SUMMER STREET, BOSTON, MA, 02110, US

(21) Appl. No.: 12/854,322

(22) Filed: Aug. 11, 2010

Related U.S. Application Data
(60) Provisional application No. 61/232,835, filed on Aug. 11, 2009.

(51) Int. Cl. F41C 27/00; B23P 17/00

(52) U.S. Cl. 42/90; 29/428

(57) ABSTRACT

A small, lightweight, easy-to-carry tool for performing various maintenance functions on an object, such as a firearm, has complementary mating halves which are removably joinable and includes a screwdriver with interchangeable and removable bits and a pin, both of which are storable within recesses in the tool body. One of the tool body halves may further contain a number of shaped projections or bits on a surface thereof useful in maintenance of firearms.

### CROSS REFERENCE TO RELATED APPLICATIONS

The present application claims priority of co-pending U.S. Provisional Application Ser. No. 61/232,835 filed Aug. 11, 2009 and entitled FIREARM TOOL SYSTEM AND METHOD FOR USING, which is incorporated by reference herein in its entirety for all purposes.

### BACKGROUND

The present teachings relate generally to firearms and, more particularly, to tools for assembling, disassembling and cleaning firearms, although not limited thereto.

Multiple conventional hand tools such as screwdrivers, pliers, and punches are often used for performing various tasks on firearms. Multipurpose firearm tools typically include a screwdriver for removing grip screws. Such multipurpose tools may have interchangeable bits of different shapes and sizes to aid in the removal and installation of springs and other firearm elements of varying sizes. One such bit may be an elongated pin used to release magazine catch pins.

However, these tools are generally large, bulky and heavy. Conventionally-sized bits also may not be able to access hard-to-reach areas in a firearm and may slip off and scratch the firearm. Certain manufactures and models of firearms have unique characteristics and cannot use conventional tools. Even a wide range of conventional tools may still not be able to perform every function on a particular firearm.

Therefore, it would be beneficial to have a superior firearm tool system and method of use which facilitates the removal and installation of springs and other firearm elements of varying sizes.

The needs set forth herein as well as further and other needs and advantages are addressed by the present embodiments, which illustrate solutions and advantages described below.

### SUMMARY

A small, lightweight, easy-to-carry tool for performing various maintenance functions on an object, such as a firearm, has complementary mating halves which are removably joinable and include a screwdriver with interchangeable and removable bits and a pin, both of which are storable within recesses in the tool body. One or both halves may further contain a number of shaped projections or bits on a surface thereof useful in maintenance of firearms.

According to one aspect of the invention, a firearm tool comprises: a body comprising two removably joinable portions; one of the portions having a pin extending outwardly therefrom and the other of the portions having a pin recess shaped to receive the pin therein when the two portions are joined; one of the portions having a screwdriver extending outwardly therefrom and the other of the portions having a screwdriver recess shaped to receive the screwdriver bit therein when the two portions are joined; and a mechanism for maintaining the portions removably joined, wherein the two portions are joinable in a complementary mating manner such that the pin of one portion is received in the pin recess of the other portion and the screwdriver bit of one portion is received in the screwdriver recess of the other portion.

According to another aspect of the invention, a method for manufacturing a firearm tool, comprises: A) providing a body comprising two removably joinable portions; B) securing a pin to extend outwardly from one of the portions and providing a pin recess shaped to receive the pin therein in the other of the portions; C) securing a screwdriver to extend outwardly from one of the portions and providing a pin recess shaped to receive the screwdriver therein in the other of the portions; and D) providing a mechanism for maintaining the portions removably joined, wherein the two portions are joinable in a complementary mating manner such that the pin of one portion is received in the pin recess of the other portion and the screwdriver bit of one portion is received in the screwdriver recess of the other portion.

Other embodiments of the system and method are described in detail below and are also part of the present teachings.

For a better understanding of the present embodiments, together with other and further aspects thereof, reference is made to the accompanying drawings and detailed description.

### BRIEF DESCRIPTION OF THE DRAWINGS

FIG. 1A is an exploded view of one embodiment of the system;

FIG. 1B is a side view of one embodiment of the system;

FIG. 2 is an illustration of the end view of one embodiment of the system;

FIG. 3 illustrates an embodiment of the system employed in a firearm maintenance function; and

FIG. 4 is a schematic diagram depicting one embodiment of the pin.

### DETAILED DESCRIPTION

The present teachings are described more fully hereinafter with reference to the accompanying drawings, in which the present embodiments are shown. The following description is presented for illustrative purposes only and the present teachings should not be limited to these embodiments.

In one embodiment, although not limited thereto, the system comprises a pocket-sized firearm tool system that is easy to carry and is used to disassemble and reassemble the frame portion of firearms. Manufacturers and models of firearms may have uniquely-sized elements, and so the system may have specifically sized elements for performing functions on particular firearms such as for SIG Sauer™ hand guns. The system may comprise interchangeable screwdriver bits, a pin, and shaped bits designed to press and release firearm pins and struts in a controlled manner. While the screwdriver bits may be of a more conventional size, the pin and shaped bits may be uniquely designed to work with particular firearms.

The system may comprise interchangeable screwdriver bits for performing a variety of maintenance functions on a firearm. In one embodiment, the system may accommodate any standard screwdriver bit. For example, a “slotted” or flat screwdriver bit may be used for securing and removing screws on grip panels. Other screwdriver bit configurations such as a “Phillips-head”, hexagonal, Torx, or cross-head screwdriver bits may also be used.

The system may also comprise a pin which may be elongated and used to press out and realign horizontally aligned pivot pins in the frame of the firearm as well as to depress protrusions of magazines to facilitate their disassembly. The pin may have a slotted end, although not limited thereto, which may be used to reposition and hold small springs during handling. The pin may be manufactured from a non-ferrous metal, although not limited thereto.

The system may be manufactured from a rigid, lightweight material such as aluminum and may be in a generally rectangular shape when assembled, although not limited thereto. The system may comprise two portions which may be of identical or different sizes, each portion with elements (e.g., screwdriver bit, pin, etc.) that correspond with recesses on the opposite portion when the two portions are joined. In this way, the joined system is compact and easy to carry and may shroud and protect the screwdriver bit and pin when not in use.

When joined, the two portions may be held together magnetically and magnetic properties may allow for small ferrous parts that are removed during firearm disassembly to be temporarily held against the system to reduce the chance of loss. Magnetism may be accomplished with the use of rare earth axially polarized ring magnets and rare earth axially polarized disk magnets, although not limited thereto. The magnets may be incorporated into the system so that they are concealed and do not affect placement of the system's other elements. Additionally, other mechanisms for removably joining the two portions together are also possible, including snaps, clips, loop and pile connectors, or some other form of fastening.

The system may have shaped bits on its outside formed by recesses and flat surfaces. These shaped bits may be designed to press and release pins and struts under spring tension in a controlled manner in order to remove and reassemble them into the frame of the firearm.

A system so designed allows for disassembly, reassembly and maintenance of a firearm and magazine when a full complement of conventional tools is not readily available. It is small and compact, and made of materials that are less likely to scratch or mar the anodized surfaces of a firearm than more conventional tools made of steel. Examples of functions that a system so constructed can perform include, but are not limited to: the removal of grip screws; magazine catch and support plate removal and installation; mainspring removal; magazine disassembly; removal, installation and alignment of hammer and sear pivot pins; and the removal and installation of sear spring and decocker spring.

In one embodiment, the system may be manufactured by milling (or some other manufacturing process) the two portions from aluminum (e.g., 6061-T6, etc.), although not limited thereto. Holes may then be drilled and chamfered in each portion as required to accommodate a screwdriver bit, a pin, magnets, a roll-pin, and a lanyard hole. One portion may be manufactured with a pattern that creates recesses and flat surfaces that are used as the shaped bits and the other portion may be chamfered, although not limited thereto.

A screwdriver bit holder may be used to receive interchangeable screwdriver bits and may be manufactured out of stainless steel, although not limited thereto. In one embodiment such holder is made from stainless steel rod cut to length, chamfered, and broached with a hexagonal shape. The holder may have a spring pin hole drilled in the side at a specific orientation to the hexagonal broach so that a spring pin may retain the hexagonal insert in a consistent orientation. The hexagonal bit holder can be manufactured from a 0.375″ diameter stainless steel rod cut to length, chamfered, and broached with a ¼″ hexagonal shape. There can be a hole drilled in the side at a specific orientation to the hexagonal broach for consistent orientation to accessory bits. The hex insert can be retained in the appropriate aluminum block by using a 0.094″ stainless spring pin.

A rare earth axially polarized magnet may be magnetically affixed underneath the spring pin at the bottom of the hole as it is being inserted. The magnet helps to retain any screwdriver bits that are inserted into the screwdriver bit holder. In one embodiment, a rare earth axially polarized magnet of approximately ¼″ diameter and ⅛″ thick is magnetically attached underneath the spring pin at the bottom of the hole as it is being inserted and press-fit in the block. The slotted pin can be manufactured from a 0.118″ (3 mm) diameter stainless steel rod or other non-ferrous metal and cut to length. An approximately 0.021″ wide and 0.030″ deep groove can be cut in one end thereof. The magnets can be retained in the block with a medium viscosity liquid bearing mount compound. The magnets, which in the illustrative embodiment may be implemented with, ring-shaped, rare earth magnets may have a 0.25″ diameter and be 0.25″ thick with a 0.125″ hole in the middle and axially polarized. The magnet are inserted with a consistent polarity orientation into the appropriate holes in the aluminum blocks. Such magnets, having the above described dimensions, are commercially available from any number of manufacturers. A medium viscosity bearing mount compound may be applied to ensure proper retention in the holes.

In another embodiment, the screwdriver bit holder may be replaced as a separate component and a shaped hole could be broached, milled, cast, or pre-formed in the blocks, although not limited thereto. This would eliminate the spring pin, and a disk magnet could be glued or press-fit in the bottom of the shaped hole.

The pin may be elongated to perform various tasks related to firearm maintenance and may be manufactured from a stainless steel rod or some other non-ferrous metal, although not limited thereto. The pin may be cut to length and then a deep groove may be cut in one end to create a slotted end. The pin and a magnet or magnets may be retained in one portion of the system with a retaining compound, although not limited thereto. A low viscosity anaerobic retaining compound may be used and any plated or anodized elements may first be treated with a primer to speed the curing, although not limited thereto. The magnets may comprise two rare-earth magnets axially polarized that are inserted with a consistent polarity orientation into the appropriate holes. A retaining compound may ensure proper retention in the holes. The pin may also be manufactured from hardened brass or titanium, although not limited thereto. It is preferable that the pin is non-magnetic and it should not be easily bent, although not limited thereto.

Each portion of the system may be manufactured by molding or casting with an appropriate plastic, fiberglass, epoxy or polymer material, or by metal injection molding. Their shape could also be altered and it is not limited to a generally rectangular shape as shown in the following figures. For example, although not limited thereto, a dovetail or other protrusion could be added to allow the two portions to be attached to each other in order to increase leverage.

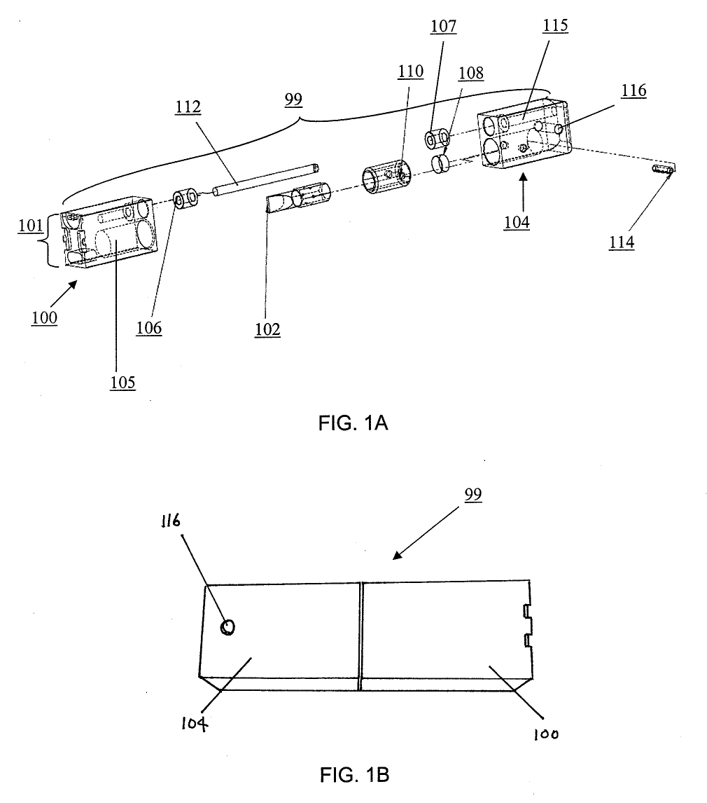

Referring now to FIG. 1A, shown is an exploded pictorial of one embodiment of the system 99. The system 99 may comprise a first portion 100 and a second portion 104 that may be joined to each other. The first portion 100 may comprise a pin 112, a magnet 106, a recess 105, and one or more shaped bits 101, although not limited thereto. The second portion 104 may comprise screwdriver bit 102, a screwdriver bit mount 110, a screwdriver bit magnet 108, a magnet 107, a spring pin 114, a second portion recess 115, and a lanyard hole 116, although not limited thereto.

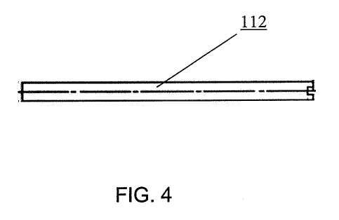

The pin 112 on the first portion 100 may be used for a number of functions related to assembling, disassembling and maintaining a firearm. The end of the pin 112 may be slotted (as shown in FIG. 4) to enable gripping of small firearm components such as springs, and does not easily slip from them while manipulating them. The shaped bits 101 may be designed to correspond with particular firearm components, discussed further below.

Similarly, the screwdriver bit 102 on the second portion 104 may be used for functions such as removing a firearm grip. The screwdriver bit 102 may rest in a screwdriver bit mount 110 so that interchangeable bits may be mounted as needed. The screwdriver bit magnet 108 assures that the screwdriver bit 102 is restrained in the screwdriver bit mount 110 by magnetic force. The spring pin 114 orients and secures the screwdriver bit mount 110 to the second portion 104. A lanyard hole 116 may be used to secure the system by using a loop of string, ring, or small chain, although not limited thereto.

When the first portion 100 is joined with the second portion 104, the screwdriver bit 102 is received in the first portion recess 105 and the pin 112 is received in the second portion recess 115 (as shown in FIG. 1B). This provides for a compact tool and protects the elements when not in use. The first portion magnet 106 and the second portion magnet 107 help to keep the two portions joined by magnetic attraction. In addition, small parts such as grip screws, magazine catch stop pins, and magazine catch stop springs may be held on the outside of the system by magnetic force to keep them from getting lost.

Referring now to FIG. 1B, shown is a photograph of one embodiment of the system 99. Here, the two portions have been joined and elements (e.g., screwdriver bit, pin, etc.) are protected in internal recesses.

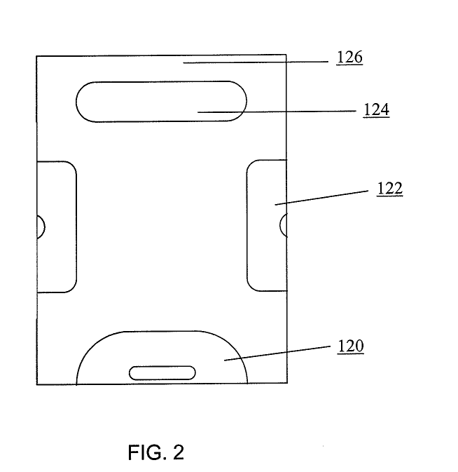

Referring now to FIG. 2, shown is an illustration of the end view of one embodiment of the system 99 (shown in FIG. 1B). The system may comprise a number of shaped bits 101 (shown in FIG. 1A) such as, although not limited thereto, a 2-piece hammer strut removal bit 120, a magazine catch removal bit 122, a 3-piece hammer strut removal bit 124, and a flat edge 126 which may be used for magazine catch support plate removal. The system may comprise any number of bits of various shapes and sizes used to perform specific tasks and is not limited to this particular embodiment.

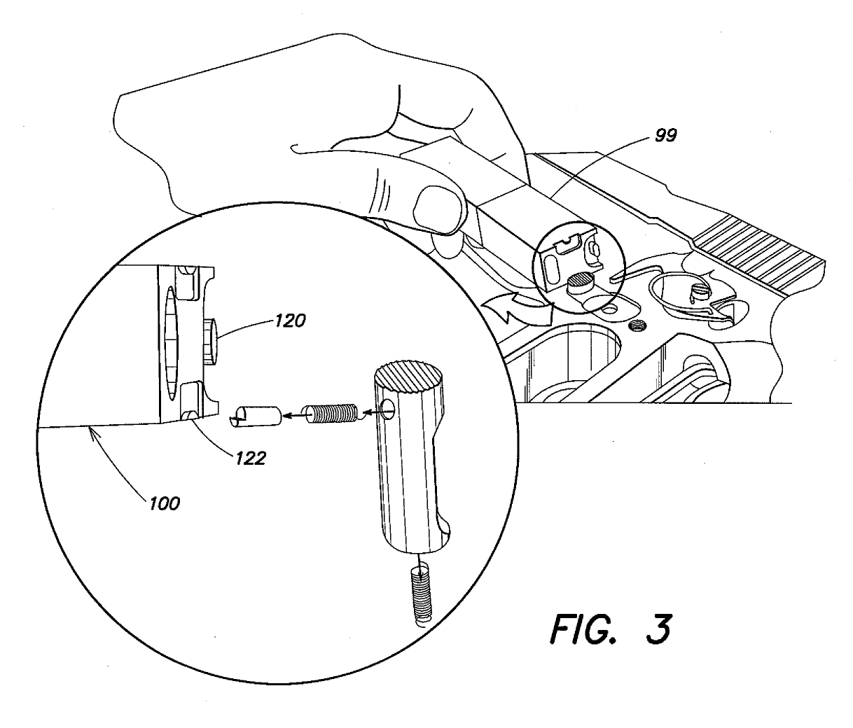

Referring now to FIG. 3, depicts an embodiment of the system 99 magazine catch removal bit 122 which may be used to depress the magazine catch stop pin. As shown, section 100 of system 99 is placed flat against the frame of a firearm, with a small protrusion of magazine catch removal bit 122 centered on the exposed cross section of the firearm magazine catch stop, the firearm and all of its component parts, including the magazine catch stop, not forming any part of the invention but illustrated only for contextual purposes.

Other firearm maintenance procedures are also made possible by the disclosed system 99. For example, the flat edge 126 of system 99 may be used for the removal of a magazine catch support plate of a pistol or other firearm. The 3-piece hammer strut removal bit 124 of system 99 may be used for depressing and lifting out an “old style” hammer strut, comprising of a strut, a metal mainspring seat and a roll-pin to retain the strut, of a pistol or other firearm. The 2-piece hammer strut removal bit 120 of system 99 may be used for depressing and lifting out a “new style” hammer strut, comprising of a strut and a plastic mainspring seat, of a pistol or other firearm.

The 2-piece hammer strut removal bit 120 may be used to cooperate with the molded recess of the plastic mainspring seat of a pistol or other firearm. The screwdriver bit 102 of system 99 may be used to remove grip plates of a pistol or other firearm.

The pin 112 of system 99 may be used to manipulate a decocker spring of a pistol or other firearm. Pin 112 may have a slotted tip for removing springs, although not limited thereto. When manipulating small firearm elements such as springs, conventional tools have a tendency to slip and scratch the firearm. The slotted tip of the pin 112 prevents such slippage. The pin 112 may be used for releasing the magazine catch stop pin or for sear spring detensioning/retensioning, when the sear spring may be depressed and moved to the side to disengage it from the sear spring pin.

Other functions include pushing out/reassembling trigger, sear, and hammer pivot pins and removing the floor plate of magazines for disassembly, although not limited thereto. For example, magazine inserts for many models of firearms have a protrusion in the bottom that engages in a hole in the magazine floor plate. This protrusion may be pressed to relieve the tension applied by the magazine spring to disengage it from the magazine floor plate to allow the floor plate to slide off the magazine tube. FIG. 4 is a schematic diagram depicting one embodiment of the pin 112 described herein.

While the present teachings have been described above in terms of specific embodiments, it is to be understood that they are not limited to these disclosed embodiments. Many modifications and other embodiments will come to mind to those skilled in the art to which this pertains, and which are intended to be and are covered by this disclosure. It is intended that the scope of the present teachings should be determined by proper interpretation and construction of the disclosure and its legal equivalents, as understood by those of skill in the art relying upon the specification and the attached drawings.

What is claimed is:

1. A firearm tool comprising:
a body comprising two removably joinable portions;
one of the portions having a pin extending outwardly therefrom and the other of the portions having a pin recess shaped to receive the pin therein when the two portions are joined;
one of the portions having a screwdriver extending outwardly therefrom and the other of the portions having a screwdriver recess shaped to receive the screwdriver bit therein when the two portions are joined; and
a mechanism for maintaining the portions removably joined;
wherein the two portions are joinable in a complementary mating manner such that the pin of one portion is received in the pin recess of the other portion and the screwdriver bit of one portion is received in the screwdriver recess of the other portion.

2. The apparatus of claim 1 wherein the body is constructed from aluminum.

3. The apparatus of claim 1 wherein the pin comprises a slotted end.

4. The apparatus of claim 1 wherein the pin comprises a non-ferrous material.

5. The apparatus of claim 1 wherein one of the portions comprises one or more shaped bits at an exterior end thereof.

6. The apparatus of claim 5 wherein the one or more shaped bits are configured for Sig pistols.

7. The apparatus of claim 1 wherein the mechanism for maintaining the portions removably joinable comprises:
a pair of axially polarized magnets, one magnet secured to each of the two body portions.

8. The apparatus of claim 1 wherein one of the two body portions comprises a lanyard loop.

9. The apparatus of claim 1 wherein the screwdriver further comprises:
a screwdriver mount configured to removably receive a screwdriver bit.

10. The apparatus of claim 9 wherein the screwdriver bit is removable and interchangeable relative to the screwdriver mount.

11. The apparatus of claim 1 wherein the body has a substantially rectangular shape.

12. The apparatus of claim 1 wherein the body comprises aluminum.

13. A method for manufacturing a firearm tool, comprising:
A) providing a body comprising two portions removably joinable portions;
B) securing a pin to extend outwardly from one of the portions and providing a pin recess shaped to receive the pin therein in the other of the portions;
C) securing a screwdriver to extend outwardly from one of the portions and providing a pin recess shaped to receive the screwdriver therein in the other of the portions; and
D) providing a mechanism for maintaining the portions removably joined;
wherein the two portions are joinable in a complementary mating manner such that the pin of one portion is received in the pin recess of the other portion and the screwdriver bit of one portion is received in the screwdriver recess of the other portion.

14. The method of claim 13 wherein the body has a substantially rectangular shape.

15. The method of claim 13 wherein A) comprises:
A 1) milling the two portions from aluminum.

16. The method of claim 13 wherein B) comprises:
B1) elongating the pin a non-ferrous material and informing a slotted end therein.
